(19) United States
(12) Patent Application Publication
(10) Pub. No.: US 2026/0197123 A1
(43) Pub. Date: Jul. 9, 2026

(54) USING A PREDICTIVE MODEL FOR UPLINK HYBRID AUTOMATIC REPEAT REQUEST RETRANSMISSION

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US); Linhai HE, San Diego, CA (US)

(21) Appl. No.: 19/012,125

(22) Filed: Jan. 7, 2025

(51) Int. Cl. H04L 1/1812; H04L 1/00; H04W 72/1268

(52) U.S. Cl. CPC H04L 1/1812; H04L 1/0061; H04W 72/1268

(57) ABSTRACT

Methods, systems, and devices for wireless communications are described. A user equipment (UE) may receive configuration information that configures the UE to use a predictive model to determine whether to terminate uplink hybrid automatic repeat request (HARQ) retransmission operation. The UE may transmit an uplink message to a network entity and receive, from the network entity, an indication that the UE is to perform uplink HARQ retransmission for the uplink message. The UE may terminate the uplink HARQ retransmission operation for the uplink message based on an output of the predictive model.

### FIELD OF TECHNOLOGY

The following relates to wireless communications, including using a predictive model for uplink hybrid automatic repeat request retransmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information that configures the UE to use a predictive model to determine whether to terminate uplink hybrid automatic repeat request (HARQ) retransmission operation, transmitting an uplink message to a network entity, receiving, from the network entity, an indication that the UE is to perform uplink HARQ retransmission for the uplink message, and terminating the uplink HARQ retransmission operation for the uplink message based on an output of the predictive model.

A UE for wireless communications is described. The UE may include one or more memories storing processor executable code, and one or more processors coupled with the one or more memories. The one or more processors may individually or collectively be operable to execute the code to cause the UE to receive configuration information that configures the UE to use a predictive model to determine whether to terminate uplink HARQ retransmission operation, transmit an uplink message to a network entity, receive, from the network entity, an indication that the UE is to perform uplink HARQ retransmission for the uplink message, and terminate the uplink HARQ retransmission operation for the uplink message based on an output of the predictive model.

Another UE for wireless communications is described. The UE may include means for receiving configuration information that configures the UE to use a predictive model to determine whether to terminate uplink HARQ retransmission operation, means for transmitting an uplink message to a network entity, means for receiving, from the network entity, an indication that the UE is to perform uplink HARQ retransmission for the uplink message, and means for terminating the uplink HARQ retransmission operation for the uplink message based on an output of the predictive model.

A non-transitory computer-readable medium storing code for wireless communications is described. The code may include instructions executable by one or more processors to receive configuration information that configures the UE to use a predictive model to determine whether to terminate uplink HARQ retransmission operation, transmit an uplink message to a network entity, receive, from the network entity, an indication that the UE is to perform uplink HARQ retransmission for the uplink message, and terminate the uplink HARQ retransmission operation for the uplink message based on an output of the predictive model.

Some examples of the method, UEs, and non-transitory computer-readable medium described herein may further include operations, features, means, or instructions for determining a block error rate estimation for uplink communications based on transmitting the uplink message, where the output of the predictive model may be based on the block error rate estimation for the uplink communications.

Some examples of the method, UEs, and non-transitory computer-readable medium described herein may further include operations, features, means, or instructions for determining a loss rate estimation for uplink communications based on transmitting the uplink message, where the output of the predictive model may be based on the loss rate estimation for uplink communications, a target loss rate threshold for an application associated with the uplink message, status of the application, a latency requirement of the application, or any combination thereof.

In some examples of the method, UEs, and non-transitory computer-readable medium described herein, the output of the predictive model may be based on a buffer status of a buffer at the UE, a power status of the UE, a resource availability status of the UE, a memory status of the UE, an application status, or any combination thereof.

In some examples of the method, UEs, and non-transitory computer-readable medium described herein, the output of the predictive model may be based on a first quantity of HARQ retransmissions for the uplink message or a second quantity of automatic repeat request (ARQ) retransmissions for the uplink message, or both.

In some examples of the method, UEs, and non-transitory computer-readable medium described herein, the output of the predictive model may be a terminating output and the method, apparatuses, and non-transitory computer-readable medium may include further operations, features, means, or instructions for transmitting at least one retransmission of the uplink message based on an early output of the predictive model, where the early output may be determined prior to determination of the terminating output.

Some examples of the method, UEs, and non-transitory computer-readable medium described herein may further include operations, features, means, or instructions for multiplexing uplink control information with a transmission of the uplink message or a retransmission of the at least one retransmission, where the uplink control information includes an indication that the retransmission may be a last retransmission of the uplink message.

Some examples of the method, UEs, and non-transitory computer-readable medium described herein may further include operations, features, means, or instructions for transmitting an uplink control information message including an indication that a retransmission of the at least one retransmission may be a last retransmission for the uplink message.

Some examples of the method, UEs, and non-transitory computer-readable medium described herein may further include operations, features, means, or instructions for inputting, to the predictive model, one or more parameters including HARQ retransmission information, automatic repeat request (ARQ) retransmission information, a discard rate, a radio link control (RLC) block error rate, a loss rate, latency information, or throughput information to obtain the output of the predictive model.

Some examples of the method, UEs, and non-transitory computer-readable medium described herein may further include operations, features, means, or instructions for transmitting a control message indicating one or more key performance indicators associated with the predictive model, where the one or more key performance indicators includes an RLC protocol data unit (PDU) latency, an RLC PDU reliability, or an uplink packet discard rate.

In some examples of the method, UEs, and non-transitory computer-readable medium described herein, the RLC PDU latency and the RLC PDU reliability may be determined per PDU set, per quality of service (QoS) flow, or per packet categorization.

Some examples of the method, UEs, and non-transitory computer-readable medium described herein may further include operations, features, means, or instructions for transmitting a capability message indicating a capability of the UE to use the predictive model to determine whether to terminate uplink HARQ retransmission operation.

In some examples of the method, UEs, and non-transitory computer-readable medium described herein, the capability message indicates one or more key performance indicators associated with the predictive model and a model score associated with the predictive model based on the one or more key performance indicators.

In some examples of the method, UEs, and non-transitory computer-readable medium described herein, terminating the uplink HARQ operation for the uplink message may include operations, features, means, or instructions for discarding one or more uplink packets that may be buffered for retransmission of the uplink message.

In some examples of the method, UEs, and non-transitory computer-readable medium described herein, the configuration information indicates a minimum quantity of retransmissions to attempt prior to terminating uplink HARQ retransmission operation, a minimum time before terminating uplink HARQ transmission operation, as maximum time before terminating uplink HARQ transmission protocol data unit (PDU), a parameter that configures the UE to use the predictive model, and identifiers for quality of service (QoS) flows, radio bearers, logical channels, or traffic types for which the UE may be to use the predictive model to determine whether to terminate uplink HARQ retransmission operation, or any combination thereof.

In some examples of the method, UEs, and non-transitory computer-readable medium described herein, the configuration information indicates one or more key performance indicators associated with the predictive model, the one or more key performance indicators including a threshold RLC block error rate, a threshold HARQ block error rate, a threshold discard rate, a threshold quantity of wasted grants, a threshold latency, a threshold quantity of traffic that meets a latency target, a throughput target, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports using a predictive model for uplink hybrid automatic repeat request retransmission in accordance with one or more aspects of the present disclosure.

FIG. 2 shows an example of a wireless communications system that supports using a predictive model for uplink hybrid automatic repeat request retransmission in accordance with one or more aspects of the present disclosure.

FIG. 3 shows an example of a process flow that supports using a predictive model for uplink hybrid automatic repeat request retransmission in accordance with one or more aspects of the present disclosure.

FIGS. 4 and 5 show block diagrams of devices that support using a predictive model for uplink hybrid automatic repeat request retransmission in accordance with one or more aspects of the present disclosure.

FIG. 6 shows a block diagram of a communications manager that supports using a predictive model for uplink hybrid automatic repeat request retransmission in accordance with one or more aspects of the present disclosure.

FIG. 7 shows a diagram of a system including a device that supports using a predictive model for uplink hybrid automatic repeat request retransmission in accordance with one or more aspects of the present disclosure.

FIGS. 8 through 11 show flowcharts illustrating methods that support using a predictive model for uplink hybrid automatic repeat request retransmission in accordance with one or more aspects of the present disclosure.

### DETAILED DESCRIPTION

A user equipment (UE) may transmit uplink messages to a network entity, and the network entity may transmit downlink control information indicating hybrid automatic repeat request (HARQ) feedback for the uplink message. The HARQ feedback may indicate whether the UE is to retransmit the uplink message or transmit a new uplink message. In some cases, the network entity may set a static quantity of HARQ re-transmission before toggling a new data indication (NDI) bit, and the indication of the NDI bit may trigger the UE to send a new uplink message. In some systems, the UE may not be aware of whether the HARQ retransmissions were successful until the UE later receives a radio link control (RLC) status report. Uplink retransmission using these techniques may have a long round-trip time (RTT), including transmission of the uplink messages and transmission of the HARQ feedback, which may reduce uplink throughput and increase latency.

A wireless communications system described herein may support techniques for a UE to use a predictive model to determine whether to retransmit an uplink message or to terminate HARQ operation for the uplink message. For example, the UE may transmit an uplink message and receive an indication to retransmit the uplink message, such as downlink control information indicating HARQ feedback. The UE may query the predictive model after every transmission or HARQ retransmission, and an output of the predictive model may indicate whether the UE is to retransmit the uplink message or flush the HARQ buffer and terminate HARQ operation for the uplink message. The output of the predictive model may be based on a UE estimate of current block error rate, UE context awareness on a current application lost rate compared to a threshold application loss rate, or latency requirements of the application. In some examples, the output of the predictive model may be based on a ratio of HARQ retransmissions and automatic repeat request (ARQ) retransmissions. In some examples, the UE may transmit an indication that a retransmission is a last retransmission based on the output of the predictive model indicating to terminate HARQ operations. For example, the UE may transmit an uplink control information message or multiplex uplink control information with a retransmission to indicate that the retransmission is a last retransmission attempt. The UE may maintain, and in some cases report, key performance indicators (KPIs) associated with the predictive model. In some examples, the UE may transmit a capability message indicating the UE supports using the predictive model for uplink communications. The capability message may indicate KPIs associated with the predictive model or a model score for the predictive model based on the KPIs. The network entity may configure the UE with a configuration for using the predictive model, including a range of minimum and maximum retransmission attempts before terminating HARQ operation, whether the UE is enabled to use the predictive model for determining whether to terminate HARQ operation, and specific quality of service (QoS) flow, radio bearers, logical channels, and traffic types the UE may use the predictive model for.

Aspects of the disclosure are initially described in the context of wireless communications systems. Aspects of the disclosure are further illustrated by and described with reference to apparatus diagrams, system diagrams, and flowcharts that relate to using a predictive model for uplink hybrid automatic repeat request retransmission.

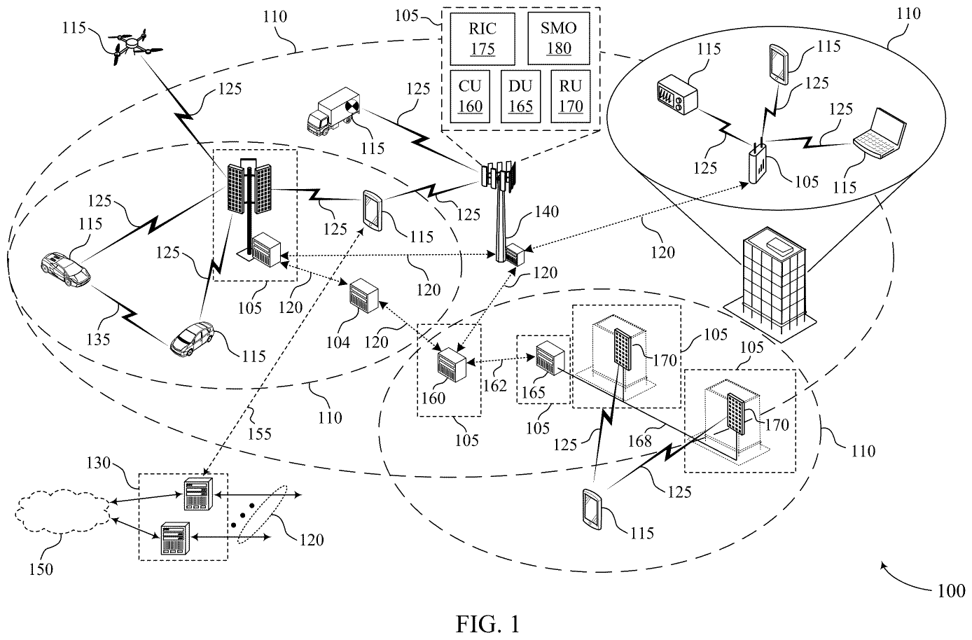

FIG. 1 shows an example of a wireless communications system 100 that supports using a predictive model for uplink hybrid automatic repeat request retransmission in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1) (e.g., physical (PHY) layer) or L2 (e.g., RLC layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support using a predictive model for uplink hybrid automatic repeat request retransmission as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Nf may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., ARQ). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may be configured with or use a predictive model. In some examples, the predictive model may be based on an artificial intelligence/machine learning (AI/ML) model. The predictive model may be a data-driven algorithm that applies AI/ML techniques to generate a set of outputs based on a set of inputs. The predictive model may be described by a model structure, such as a computation graph, and a parameter set, such as neural network weights.

A machine learning feature name (MLFN) may identify a certain functionality for a predictive model. For example, a predictive model may be associated with CSI feedback, beam management, positioning, or any combination thereof, which may correspond to the MLFN. Predictive models associated with the MLFN may be identified by a model identifier or a model structure identifier. For a model identifier, the network may configure the predictive model without parameters. For a model structure identifier, the network may configure the model and separate parameter sets. Model identifiers and model structure identifiers may be unique per MLFN, such as to identify separate models.

A predictive model may be a UE-side predictive model, a network-side predictive model, or a UE-network two-sided predictive model. For a UE-side predictive model, inference may be performed at a UE 115. In some examples, the UE 115 may receive predictive model-specific control signaling or input from the network. For a network-side predictive model, inference may be performed at the network. In some examples, the network may receive predictive model-specific input from a UE 115. UE-network two-sided predictive models may correspond to paired predictive models over which joint inference is performed. Joint inference may include predictive model inference whose inference is performed jointly across a UE 115 and the network. For example, a first part of inference may be performed by the UE 115, and a remaining part of inference may be performed by a network entity 105. For a UE-network two-sided predictive model, the UE 115 may receive predictive model-specific control signaling or input from the network entity 105, or the network entity 105 may receive predictive model-specific control signaling from the UE 115.

A predictive model may be developed, deployed, and executed. Model development may include defining use cases, data collection, and model development. Model deployment may include compiling predictive model information and obtaining updated predictive model information. Model execution may include configuring the predictive model at a device, activating the predictive model at the device, obtaining inference information or training the predictive model at the device, and monitoring the predictive model at the device (e.g., monitoring performance of the predictive model).

A configuration for a predictive model at a UE 115 may include parameters for model management, input data, and for monitoring key performance indicators (KPIs). Model management parameters may include a model interface configuration, including an MLFN, model identifier, model structure identifier, parameter sets, and other configurations which may be used with the predictive model, such as measurement configurations or a MAC configuration. Input data parameters may include, for example, data or meta-data which may be used for predictive model inference. Monitoring parameters, or KPI monitoring parameters, may include monitoring input data, such as meta-data (e.g., for model switch decisions) or ground truth data (e.g., for model KPI evaluation), monitoring report parameters (e.g., feedback KPIs, system KPIs, or inference KPIs), and parameters for model switching events (e.g., reports based on monitoring or feedback KPIs).

In some examples, a UE 115 may indicate which predictive model features and corresponding predictive models are supported by the UE 115. In some examples, the network may configure the use of prediction techniques (e.g., using a predictive model) at the UE 115, and the UE 115 may indicate predictive model capabilities, including a list of MLFNs at the UE 115. In some examples, the network may configure a specific machine learning model (e.g., associated with a specific model identifier) for a feature at the UE 115, and the UE may indicate predictive model capabilities, such as a list of MLFNs including model identifiers supported per MLFN and a flag if a predictive model is currently loaded at the UE 115. In some examples, the network may configure a specific model structure (e.g., associated with a specific model structure identifier) and parameter set for a feature. The UE 115 may report a list of MLFNs, including a list of model structure identifiers per MLFN.

The network may configure a predictive model using different layers of signaling. In some examples, a network entity 105 may transmit L3 signaling to configure a predictive model, a configuration includes relevant information elements based on scenarios where the predictive model may be used. In some examples, a network entity 105 may transmit L2 signaling to activate or deactivate a predictive model.

In some wireless communications systems, a UE 115 may attempt to achieve an operating point based on radio conditions and an application state of an application at the UE 115. The UE 115 may perform techniques which enable the UE 115 to control HARQ and tailor HARQ procedures to traffic patterns in terms of throughput and latency at a controlled loss rate.

In some examples, a network entity 105 may schedule a threshold or maximum quantity of retransmissions for an uplink message. For example, the network entity 105 may schedule between four and seven HARQ retransmissions of an uplink message before the network entity 105 toggles an NDI, configuring the UE 115 to transmit new data, even if the network entity 105 did not successfully obtain the previous uplink message. This may correspond to a HARQ residual block error rate (BLER) with a very a very low value, except for some very high HARQ BLER scenarios due to very poor radio conditions.

For example, a downlink channel may have a 10% independent and identically distributed BLER with a 5 millisecond HARQ round-trip time. An application may have a packet delay budget of 10 milliseconds may have a tolerance of 0.1% error rate. Without considering buffering latency, performance may be improved for the application by flushing a HARQ buffer after two retransmissions based on the 10 millisecond latency and the 0.1% residual HARQ. Flushing the HARQ buffer after a higher quantity of retransmissions, such as the four to seven HARQ retransmissions frequently implemented in some systems, may correspond to more than 0.1% of traffic being delayed beyond a tolerated limit at lower spectral efficiency. Extra latency may come from delayed packets competing with new packets for HARQ resources.

In some examples, a UE 115 may support forward error correction (FEC) encoding. A UE 115 which supports FEC encoding may forego retransmissions (e.g., of parity packets) if the UE 115 can determine that a receiver has received sufficient data packets to decode the block or uplink message.

The wireless communications system 100, and wireless communications systems described herein, may implement techniques for using a predictive model for a retransmission scheme. For example, with each transmission or HARQ retransmission of an uplink message, the UE may, based on an output of a predictive model, determine whether to perform a retransmission of the uplink message if the transmission failed or discard the uplink message if the transmission failed. For example, the UE 115 may receive downlink control information indicating HARQ feedback for the uplink message. In some examples, the UE 115 may retransmit the uplink message based on an NDI indicated by the downlink control information or flush a HARQ buffer based on the NDI. In some examples, the UE 115 may retransmit a MAC protocol data unit (PDU) of the uplink message and then flush the HARQ buffer. For example, the UE 115 may discard the PDU even in the event of HARQ failure for the MAC PDU of the uplink message.

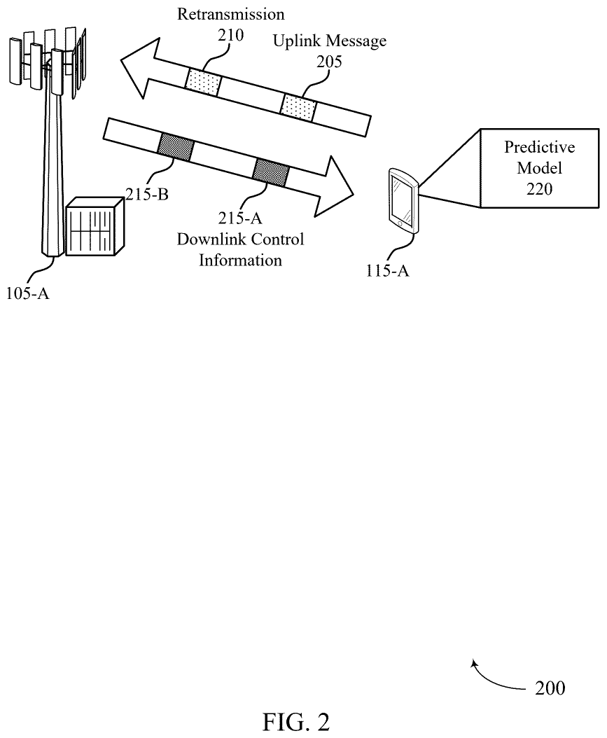

FIG. 2 shows an example of a wireless communications system 200 that supports using a predictive model for uplink hybrid automatic repeat request retransmission in accordance with one or more aspects of the present disclosure. The wireless communications system 200 may implement aspects of a wireless communications system 100. For example, the wireless communications system 200 may include a UE 115-a and a network entity 105-a, which may be respective examples of a UE 115 and a network entity 105 described herein.

The network entity 105-a may transmit control signaling to schedule the UE 115-a to transmit uplink signaling, such as an uplink message 205, or to receive downlink signaling. For example, the network entity 105-a may grant uplink resources for the UE 115-a to transmit the uplink message 205, and the UE 115-a may transmit the uplink message 205 to the network entity 105-a using the granted uplink resources. In some examples, the network entity 105-a may transmit downlink control information, such as downlink control information 215, via a physical downlink control channel to grant the uplink resources.

In case of transmission failure, or instances where an intended receiver does not correctly decode or obtain a transmission, the UE 115-a and the network entity 105-a may support one or more retransmission schemes, such as HARQ or ARQ. For example, the network entity 105-a may not be able to decode the uplink message 205, and the network entity 105-a may transmit downlink control information 215-a including HARQ feedback that indicates a negative acknowledgment (NACK) for the uplink message 205.

The wireless communications system 200 may support techniques for a UE 115, such as the UE 115-a, to make HARQ determinations based on an output of a predictive model 220. For example, the UE 115-a may be configured with a predictive model 220, and the UE 115-a may receive HARQ feedback indicating a NACK. The UE 115-a may determine whether to terminate HARQ operation for the uplink message based on an output of the predictive model 220. For example, the UE 115-a may transmit a retransmission 210 of the uplink message 205 and flush a HARQ buffer even if the downlink control information 215-a does not include an NDI, or if the NDI bit in the downlink control information does not indicate for the UE 115-a to transmit new data.

Use of the predictive model 220, or use of the output of the predictive model 220, to determine whether to terminate HARQ operation at the UE 115 may be referred to as a behavior of the UE 115. For example, these techniques may be referred to as AI native uplink HARQ behavior. AI native behavior in uplink may correspond to a UE 115 using AI/ML techniques to determine operate at the UE 115, such as querying the predictive model 220 to determine how to perform HARQ operation at the UE 115. In some examples, parameters for this behavior, including a range configuration, metrics or KPIs, and whether to operate according to this behavior, may be configured by the network, such as being configured by the network entity 105-a.

For example, the UE 115-a may use the predictive model to determine whether the UE 115-a is to retransmit a MAC PDU or discard the MAC PDU if the network entity 105-a transmits downlink control information 215 indicating HARQ failure. In some examples, the determination, or the output of the predictive model 220, may be based on an estimate of uplink RLC BLER or uplink HARQ BLER. Additionally, or alternatively, the output of the predictive model may be based on a context awareness of an application associated with the MAC PDU, such as a target loss rate of the application compared to a current or estimated loss rate. Additionally, or alternatively, the output of the predictive model may be based on a latency target or latency requirement of the application. For example, the uplink RLC BLER, uplink HARQ BLER, context awareness of an application, or current loss rate compared to a target loss rate of the application, or any combination thereof, may be used as inputs for the predictive model 220 to generate the output.

In some examples, the UE 115-a may determine whether to terminate HARQ operation based on a buffer status of the UE 115-a or resource utilization at the UE 115-a. For example, the UE 115-a may determine whether to terminate HARQ operation (e.g., terminate HARQ operation early or without receiving a new data indication) based on buffer availability, power availability, power usage, memory availability, or memory usage, or any combination thereof. Additionally, or alternatively, the output of the predictive model may be based on the buffer status of the UE 115-a or resource utilization at the UE 115-a. For example, the buffer status or resource utilization of the UE 115-a may be used as inputs for the predictive model 220 to generate the output.

In some examples, the UE 115-a may query the predictive model 220 after each transmission or retransmission. For example, the UE 115-a may query the predictive model after a transmission of the uplink message 205 or after the transmission of the retransmission 210, or both. The UE 115-a may determine, based on the output of the predictive model, whether to retransmit if downlink control information 215 instructs the UE 115-a to retransmit or whether to discard the transmission and flush the HARQ buffer.

For example, the UE 115-a may transmit the uplink message 205, and the UE 115-a may query the predictive model 220. The predictive model may generate an output, and the UE 115-a may determine whether to perform retransmission of the uplink message 205 if the UE 115 receives HARQ feedback indicating a NACK for the uplink message 205 or whether to flush a HARQ buffer corresponding to the uplink message 205. In an example, the UE 115-a may determine to perform retransmission of the uplink message 205 in case of HARQ failure based on the output of the predictive model 220. The UE 115-a may receive downlink control information 215-a indicating a NACK or HARQ failure for the uplink message 205. For example, an NDI field of the downlink control information 215-a may not indicate to transmit new data. The UE 115-a may query the predictive model 220, and an output of the predictive model 220 may indicate for the UE 115-a to terminate HARQ operations for the uplink message 205 early. The UE 115-a may transmit a retransmission 210 of the uplink message 205 and flush a HARQ buffer corresponding to the uplink message 205. For example, the UE 115-a may discard a MAC PDU corresponding to the uplink message 205 based on the output of the predictive model 220.

In some examples, the UE 115-a may determine whether to terminate HARQ operation based on a target quantity of HARQ retransmissions or a target quantity of ARQ retransmissions, or both. For example, the UE 115-a may perform joint optimization on HARQ and ARQ to obtain a threshold, or maximum, quantity of HARQ retransmissions and a threshold, or maximum, quantity of ARQ retransmissions. The UE 115-a may tailor the ratio of HARQ retransmissions and ARQ retransmissions to radio conditions and a target error rate. In some examples, the UE 115-a may transmit ARQ retransmissions and HARQ retransmissions on separate component carriers in a carrier aggregation configuration. In some examples, the quantity of HARQ retransmissions, the quantity of ARQ retransmissions, or a ratio of HARQ retransmissions to ARQ retransmissions may be used as inputs to the predictive model 220 to generate the output of the predictive model 220. In some other examples, the quantity of HARQ retransmissions, the quantity of ARQ retransmissions, or a ratio of HARQ retransmissions to ARQ retransmissions may be separate from the output of the predictive model 220. For example, the UE 115-a may determine whether to terminate HARQ operation based on the quantity of HARQ retransmissions, the quantity of ARQ retransmissions, or a ratio of HARQ retransmissions to ARQ retransmissions and the output of the predictive model 220.

In some wireless communications systems, the network may expect a retransmission if a network entity 105 instructs a UE 115 to retransmit based on the network entity 105 transmitting downlink control information without a toggled NDI to the UE 115. The network entity 105 may expect the downlink control information to be followed, and for the UE 115 to transmit a retransmission when the network entity 105 transmits downlink control information without a toggled NDI to the UE 115.

The wireless communications system 200 may support techniques for a UE 115, such as the UE 115-a, to indicate whether a transmission is a new transmission or retransmission, such as a last retransmission of a MAC PDU. In some examples, if the UE 115-a is configured to use the predictive model 220 for HARQ determinations, the UE 115-a may multiplex uplink control information with a transmission, such as the uplink message 205 or the retransmission 210. The uplink control information may include a bit which indicates whether the transmission is a last transmission of a PDU. For example, the UE 115-a may multiplex uplink control information with the retransmission 210, and the uplink control information may include a bit which indicates that the retransmission 210 is a last retransmission of a MAC PDU (e.g., originally transmitted via the uplink message 205). The network entity 105-a may receive the retransmission 210 that is multiplexed with uplink control information, and the network entity 105-a may determine to toggle an NDI in a next downlink control information, such as a downlink control information 215-b.

In some examples, the UE 115-a may multiplex uplink control information with a transmission, and the uplink control information may indicate whether the transmission is a new transmission or a retransmission. For example, the uplink control information may include an NDI field. The UE 115-a may multiplex first uplink control information with the uplink message 205, and an NDI in the first uplink control information may indicate that the uplink message 205 is a new transmission, or includes a first transmission of a MAC PDU. The UE 115-a may multiplex second uplink control information with the retransmission 210, and an NDI in the second uplink control information may indicate that the retransmission 210 is a retransmission. If the UE 115-a transmits an uplink data message that is multiplexed with uplink control information to the network entity 105-a, and the uplink control information includes a toggled NDI (e.g., an NDI of the uplink control information indicates that the uplink data message is a new data message), the network entity 105-a may determine that the UE 115-a discarded a previous MAC PDU or flushed a HARQ buffer for the previous MAC PDU.

In some examples, the predictive model 220 may generate the output based on observed RLC parameters, HARQ parameters, RLC events, or HARQ events. In some examples, the RLC and HARQ parameters and events may be observed by the UE 115-a or the predictive model 220 and may be used as inputs to the predictive model 220. In some examples, the predictive model 220 may observe RLC and HARQ parameters or events to estimate RLC and HARQ BLER for different radio bearers or QoS flows. In some examples, the predictive model 220 may observe RLC and HARQ parameters or events to estimate a throughput, latency, or loss rate, or any combination thereof, of traffic, such as when using an uplink HARQ retransmit or discard policy. For a prediction approach of HARQ retransmission, the UE 115-a may use the predictive model 220 to predict a quantity of retransmissions that corresponds to a successful transmission of a transport block. For a threshold quantity of retransmissions approach, the UE 115-a may use the predictive model 220 to determine a target or optimal quantity of retransmissions before discarding a MAC PDU.

In some examples, the UE 115-a or the predictive model 220, or both, may collect data, which may be at least partially used as inputs for the predictive model 220. In some examples, collecting data may correspond to identifying the data or determining the data. For example, the UE 115-a may collect information, or logs, of HARQ transmissions and RLC status reports that are received at the UE 115-a. The UE 115-a may determine, or identify, logs of HARQ transmissions and HARQ retransmissions and RLC retransmissions, such as if the UE 115-a is configured for RLC acknowledged mode. In some examples, the UE 115-a may determine, or identify, a discard rate and statistics on HARQ retransmissions. In some examples, the UE 115-a may determine, or identify, an RLC BLER or an overall loss rate. The RLC BLER or overall loss rate may be estimated by the UE 115-a, or the network (e.g., the network entity 105-a) may indicate the RLC BLER or overall loss rate to the UE 115-a. In some examples, the UE 115-a may determine, or identify, an observed latency and throughput on a link, such as an uplink from the UE 115-a to the network entity 105-a.

In some examples, the UE 115-a may maintain KPIs related to performance of uplink communications. The UE 115-a may collect the KPIs and may report the KPIs to the network, via the network entity 105-a, or a server associated with the predictive model 220. In some examples, the UE 115-a may maintain KPIs related to latency. For example, the KPIs related to latency may correspond to statistics of RLC PDU latency or reliability per PDU set, QoS flow, radio bearer, or any packet categorization. The KPIs on latency may indicate whether a UE policy for determining whether to perform HARQ retransmission or terminate HARQ operation is satisfying latency conditions. In some examples, the KPIs on latency may indicate throughput for packets that are delivered under the packet delay budget. In some examples, the UE 115-a may maintain KPIs related to the predictive model 220. For example, a KPI related to the predictive model may correspond to how much discard is happing, such as when the UE 115-a determines to terminate HARQ operation early. Quantifying the amount of discard happening at the UE 115-a may correspond to how often grants are “wasted,” or how frequently granted resources are not being used by the UE 115-a.

In some examples, the network, such as the network entity 105-a, may maintain one or more KPIs. For example, the network entity 105-a may observe throughput and discard rate on the link based on decoding UCIs indicating that the UE 115-a has discarded. Additionally, or alternatively, the network entity 105-a may track an RLC BLER by observing which RLC or PDCP sequence numbers are successfully received.

In some examples, the UE 115-a may transmit capability information to the network entity 105-a. For example, the capability information may indicate a capability of the UE 115-a to perform HARQ retransmissions or HARQ operation using the predictive model 220. In some examples, the UE 115-a may report which KPIs the UE 115-a supports for measuring throughput, latency, or loss. In some examples, the UE 115-a may report a model score for the predictive model 220 based on KPI achievement, or KPI tracking, and testing.

In some examples, the network entity 105-a may transmit control signaling that configures the UE 115-a to use the predictive model 220. Additionally, or alternatively, the control signaling may indicate parameters for using the predictive model 220. In some examples, a configuration for the UE 115-a to use the predictive model 220 for HARQ determinations may include a range configuration and a KPI configuration.

For example, a range configuration may include a first threshold quantity of retransmissions to attempt before discarding. For example, the first threshold quantity may be a minimum quantity of retransmissions the UE 115-a should perform prior to discarding a MAC PDU or terminating HARQ operation early. The range configuration may include a first threshold time before discarding or a second threshold time before discarding, or both. For example, the range configuration may indicate a minimum amount of time before a PDU is eligible for discard and a maximum amount of time before the UE 115-a is to discard the PDU. A start time (e.g., used to determine a comparison to the first threshold time and the second threshold time) may be determined from the time any part of a PDU is received at a PDCP layer of the UE 115-a. The range configuration may include an indication of whether HARQ determinations at the UE 115-a using the predictive model 220 are allowed or enabled. In some examples, the range configuration may include an indication of QoS flows, radio bearers, logical channels, or traffic types for which HARQ determinations using the predictive model 220 is allowed.

A KPI configuration may include KPIs configured by the network, such as the network entity 105-b, for the UE 115-a to use when using the predictive model 220 to determine whether to terminate HARQ operation. The KPI configuration may include an RLC BLER KPI, corresponding to a target, or maximum allowed, BLER for RLC. The KPI configuration may include a HARQ residual BLER, corresponding to a target, or maximum allowed, residual BLER at HARQ. The KPI configuration may include a discard rate, corresponding to a threshold, or maximum, long-term discard rate of MAC PDUs. The KPI configuration may include a quantity of wasted grants, corresponding to a threshold quantity of grants for transmission or retransmission which can be wasted, or unused, due to eventual MAC PDU discard. The KPI configuration may include a latency target, corresponding to a target latency of PDUs. The KPI configuration may include a percent of traffic within latency, corresponding to a percentage of, or how much, traffic is successfully transmitted within a latency bound or within a target packet budget delay. The KPI configuration may include a throughput target, corresponding to a threshold, or minimum, throughput that using the predictive model 220 for HARQ determinations should achieve.

In some examples, the UE 115-a may be configured with default or fallback behavior in case a KPI is not maintained. For example, if the UE 115-a does not satisfy a set of KPIs of the configured KPIs, or one or more of the configured KPIs, the UE 115-a may change operation at the UE 115-a. In some examples, the UE 115-a may stop using the predictive model 220 to determine HARQ operation. For example, the UE 115-a may stop using an output of the predictive model 220 or may stop querying the predictive model 220 to determine whether to perform retransmission according to an NDI in a downlink control information 215 or whether to terminate HARQ operation. In some examples, the UE 115-a may transmit a KPI violation report to the network or a server associated with the predictive model 220. In some examples, the UE 115-a may disable use of the predictive model 220, or use of the output of the predictive model 220, for a specific RLC, logical channel, or QoS flow.

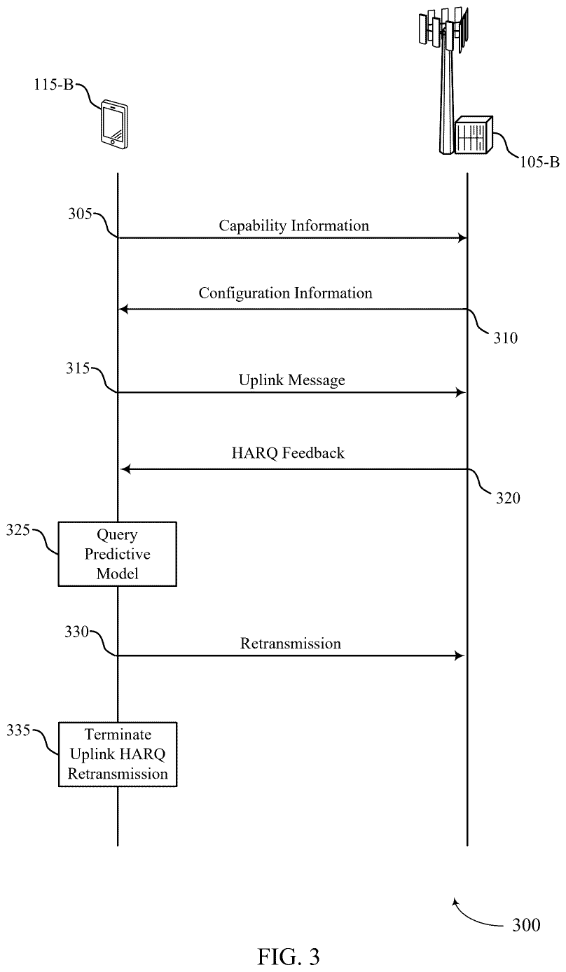

FIG. 3 shows an example of a process flow 300 that supports using a predictive model for uplink hybrid automatic repeat request retransmission in accordance with one or more aspects of the present disclosure. The process flow 300 may implement aspects of a wireless communications system 100 or a wireless communications system 200. For example, the process flow 300 may be implemented by a UE 115-b or a network entity 105-b, or both, which may be respective examples of a UE 115 and a network entity 105 described herein.

In some examples, alternative examples of the following may be implemented, where some steps are performed in a different order than described or are not performed at all. In some cases, steps may include additional features not mentioned below, or further steps may be added. Although the UE 115-a and the network entity 105-a are shown performing the operations of the process flow 300, some aspects of some operations may also be performed by one or more other wireless devices, network entities, or network devices.

In some examples, at 305, the UE 115-b may transmit information associated with a predictive model at the UE 115-b. For example, the UE 115-b may transmit a capability message indicating a capability of the UE 115-b to use the predictive model to determine whether to terminate uplink HARQ retransmission operation. In some examples, the capability message may indicate one or more KPIs associated with the predictive model. In some examples, the capability message may indicate a model score associated with the predictive model based on the one or more KPIs. The one or more KPIs indicated by the capability message may correspond to KPIs for throughput, latency, or packet loss, or any combination thereof.

At 310, the UE 115-b may receive configuration information from the network entity 105-b. In some examples, the configuration information may include a parameter that configures the UE to use the predictive model. In some examples, the UE 115-b may receive configuration information that configures the UE 115-b to use a predictive model to determine whether to terminate uplink HARQ retransmission operation.

In some examples, the configuration information may include one or more parameters related to a range configuration for using the predictive model. For example, the configuration information may indicate a minimum quantity of retransmissions to attempt prior to terminating uplink HARQ retransmission operation, a first threshold time (e.g., a minimum time) before terminating uplink HARQ retransmission operation, a second threshold time (e.g., a maximum time) before terminating the uplink HARQ retransmission operation, and identifiers for QoS flows, radio bearers, logical channels, or traffic types for which the UE is to use the predictive model to determine whether to terminate the uplink HARQ retransmission operation, or any combination thereof.

In some examples, the configuration information may include one or more parameters related to KPIs for the predictive model. For example, the configuration information may indicate one or more KPIs associated with the predictive model, the one or more KPIs including a threshold RLC block error rate, a threshold HARQ block error rate, a threshold discard rate, a threshold quantity of wasted grants, a threshold latency, a threshold quantity of traffic that meets a latency target, a throughput target, or any combination thereof.

At 315, the UE 115-b may transmit an uplink message to the network entity 105-b. For example, the network entity 105-b may transmit downlink control information that grants uplink resources to the UE 115-b, and the UE 115-b may transmit the uplink message to the network entity 105-b using the granted uplink resources.

At 320, the network entity 105-b may transmit HARQ feedback for the uplink message. For example, the UE 115-b may receive, from the network entity 105-b, an indication that the UE is to perform uplink HARQ retransmission for the uplink message. In some examples, the UE 115-b may receive downlink control information, and an NDI of the downlink control information may not be toggled, or the NDI may indicate for the UE 115-b to perform a retransmission of the uplink message.

In some examples, at 325, the UE 115-b may query the predictive model. For example, the UE 115-b may input information to the predictive model to obtain an output of the predictive model. In some examples, the UE 115-b may determine a BLER estimation for uplink communications based on transmitting the uplink message, and the output of the predictive model may be based on the BLER estimation for the uplink communications. In some examples, the UE 115-b may determine a loss rate estimation for uplink communications based on transmitting the uplink message, and the output of the predictive model may be based at least in part on the loss rate estimation for uplink communications. In some examples, the output of the predictive model may be based on a target loss rate threshold for an application associated with the uplink message, a status of the application, a latency requirement of the application, or any combination thereof. The status of the application may refer to parameters or information the UE 115-b can derive based on a UE awareness of the application. For example, based on an amount of buffered data for the application, the application may prefer to more aggressively discard packets or PDUs.

In some examples, the output of the predictive model is based on a quantity of HARQ retransmissions or ARQ retransmissions, or both. For example, the output of the predictive model may be based on a first quantity of HARQ retransmissions for the uplink message, a second quantity of ARQ retransmissions for the uplink message, or a ratio of the first quantity to the second quantity.

In some examples, querying the predictive model may include providing inputs to the predictive model. For example, the UE 115-b may input, to the predictive model, one or more parameters including HARQ retransmission information, ARQ retransmission information, a discard rate, an RLC BLER, a loss rate, latency information, or throughput information to obtain an output of the predictive model.

In some examples, at 330, the UE 115-b may transmit a retransmission of the uplink message. For example, the UE 115-b may transmit a retransmission of a MAC PDU that was transmitted via the uplink message. Additionally, or alternatively, the UE 115-b may transmit at least one retransmission of the uplink message based on an earlier output of the predictive model.

In some examples, the UE 115-b may multiplex uplink control information with a transmission of the uplink message or a retransmission of the uplink message. The uplink control information may include an indication that the retransmission is a last retransmission of the uplink message.

For example, the UE 115-b may transmit a retransmission of the uplink message at 330, and the retransmission may be multiplexed with uplink control information. The uplink control information may include an indication that the retransmission transmitted at 330 is a last retransmission of the uplink message.

In another example, the uplink message transmitted at 315 may be multiplexed with uplink control information. The uplink control information multiplexed with the uplink message may indicate that the uplink message includes new data. For example, the uplink control information multiplexed with the uplink message may include an NDI, indicating that the uplink message includes new data and is not a retransmission.

At 335, the UE 115-b may terminate the uplink HARQ retransmission operation for the uplink message based on the output of the predictive model. In some examples, the UE 115-b may discard one or more uplink packets or MAC PDUs that are buffered for retransmission of the uplink message.

In some examples, the UE 115-b may report KPIs related to uplink performance. For example, the UE 115-b may transmit a control message indicating one or more KPIs associated with uplink or the predictive model, or both. The one or more KPIs may include an RLC PDU latency, an RLC PDU reliability, or an uplink packet discard rate.

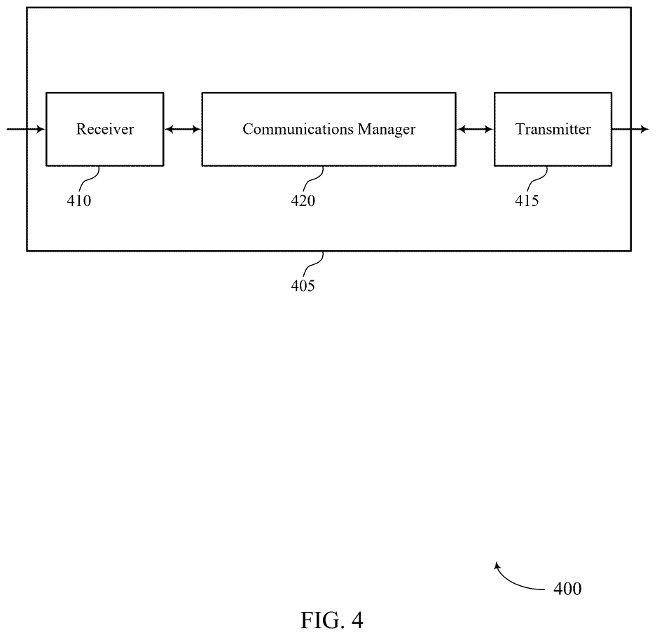

FIG. 4 shows a block diagram 400 of a device 405 that supports using a predictive model for uplink hybrid automatic repeat request retransmission in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to using a predictive model for uplink hybrid automatic repeat request retransmission). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to using a predictive model for uplink hybrid automatic repeat request retransmission). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of using a predictive model for uplink hybrid automatic repeat request retransmission as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving configuration information that configures the UE to use a predictive model to determine whether to terminate uplink HARQ retransmission operation. The communications manager 420 is capable of, configured to, or operable to support a means for transmitting an uplink message to a network entity. The communications manager 420 is capable of, configured to, or operable to support a means for receiving, from the network entity, an indication that the UE is to perform uplink HARQ retransmission for the uplink message. The communications manager 420 is capable of, configured to, or operable to support a means for terminating the uplink HARQ retransmission operation for the uplink message based on an output of the predictive model.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

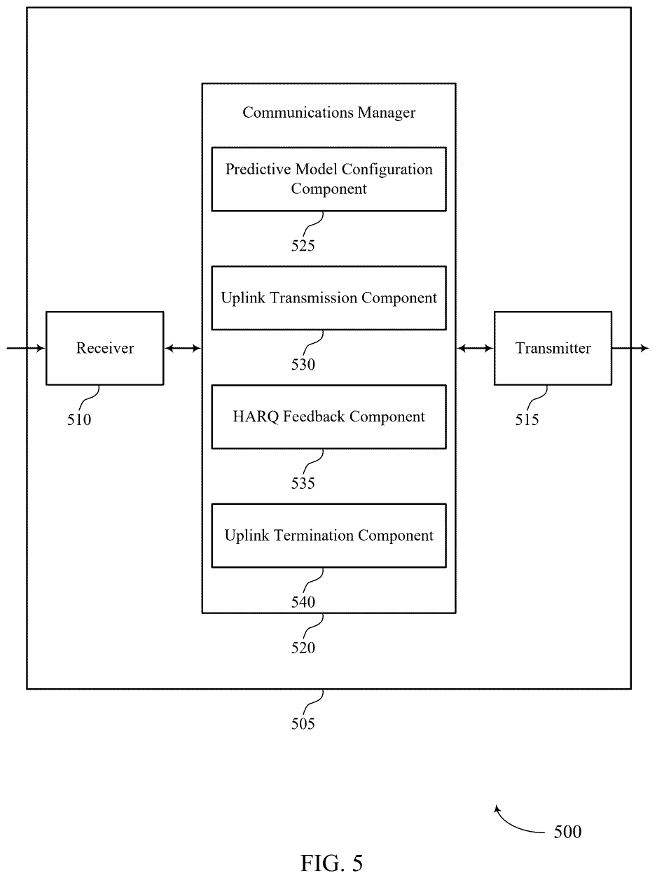

FIG. 5 shows a block diagram 500 of a device 505 that supports using a predictive model for uplink hybrid automatic repeat request retransmission in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to using a predictive model for uplink hybrid automatic repeat request retransmission). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to using a predictive model for uplink hybrid automatic repeat request retransmission). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of using a predictive model for uplink hybrid automatic repeat request retransmission as described herein. For example, the communications manager 520 may include a predictive model configuration component 525, an uplink transmission component 530, an HARQ feedback component 535, an uplink termination component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The predictive model configuration component 525 is capable of, configured to, or operable to support a means for receiving configuration information that configures the UE to use a predictive model to determine whether to terminate uplink HARQ retransmission operation. The uplink transmission component 530 is capable of, configured to, or operable to support a means for transmitting an uplink message to a network entity. The HARQ feedback component 535 is capable of, configured to, or operable to support a means for receiving, from the network entity, an indication that the UE is to perform uplink HARQ retransmission for the uplink message. The uplink termination component 540 is capable of, configured to, or operable to support a means for terminating the uplink HARQ retransmission operation for the uplink message based on an output of the predictive model.

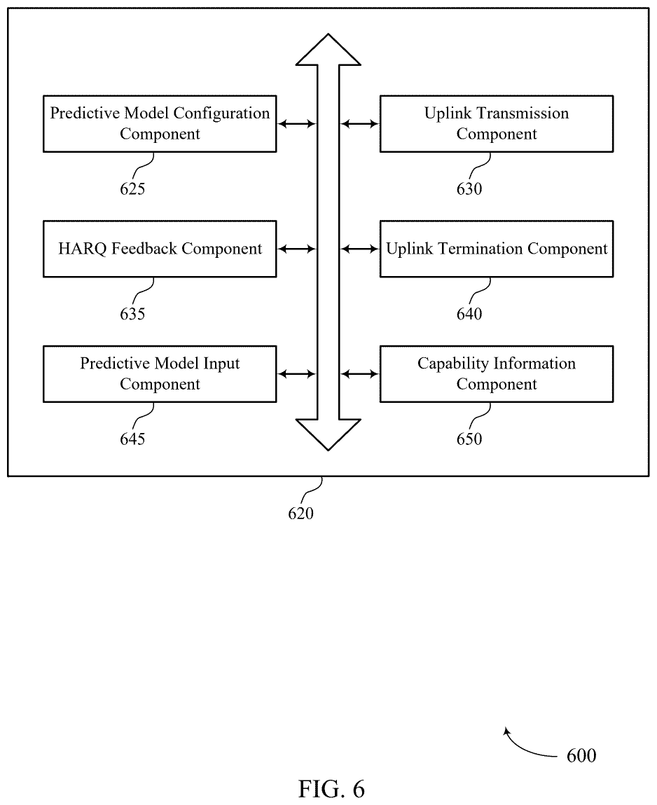

FIG. 6 shows a block diagram 600 of a communications manager 620 that supports using a predictive model for uplink hybrid automatic repeat request retransmission in accordance with one or more aspects of the present disclosure. The communications manager 620 may be an example of aspects of a communications manager 420, a communications manager 520, or both, as described herein. The communications manager 620, or various components thereof, may be an example of means for performing various aspects of using a predictive model for uplink hybrid automatic repeat request retransmission as described herein. For example, the communications manager 620 may include a predictive model configuration component 625, an uplink transmission component 630, an HARQ feedback component 635, an uplink termination component 640, a predictive model input component 645, a capability information component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The predictive model configuration component 625 is capable of, configured to, or operable to support a means for receiving configuration information that configures the UE to use a predictive model to determine whether to terminate uplink HARQ retransmission operation. The uplink transmission component 630 is capable of, configured to, or operable to support a means for transmitting an uplink message to a network entity. The HARQ feedback component 635 is capable of, configured to, or operable to support a means for receiving, from the network entity, an indication that the UE is to perform uplink HARQ retransmission for the uplink message. The uplink termination component 640 is capable of, configured to, or operable to support a means for terminating the uplink HARQ retransmission operation for the uplink message based on an output of the predictive model.

In some examples, the predictive model input component 645 is capable of, configured to, or operable to support a means for determining a block error rate estimation for uplink communications based on transmitting the uplink message, where the output of the predictive model is based on the block error rate estimation for the uplink communications.

In some examples, the predictive model input component 645 is capable of, configured to, or operable to support a means for determining a loss rate estimation for uplink communications based on transmitting the uplink message, where the output of the predictive model is based on the loss rate estimation for uplink communications, a target loss rate threshold for an application associated with the uplink message, status of the application, a latency requirement of the application, or any combination thereof.

In some examples, the output of the predictive model is based on a buffer status of a buffer at the UE, a power status of the UE, a resource availability status of the UE, a memory status of the UE, an application status, or any combination thereof.

In some examples, the output of the predictive model is based on a first quantity of HARQ retransmissions for the uplink message or a second quantity of ARQ retransmissions for the uplink message, or both.

In some examples, the output of the predictive model is a terminating output, and the HARQ feedback component 635 is capable of, configured to, or operable to support a means for transmitting at least one retransmission of the uplink message based on an early output of the predictive model, where the early output is determined prior to determination of the terminating output.

In some examples, the HARQ feedback component 635 is capable of, configured to, or operable to support a means for multiplexing uplink control information with a transmission of the uplink message or a retransmission of the at least one retransmission, where the uplink control information includes an indication that the retransmission is a last retransmission of the uplink message.

In some examples, the HARQ feedback component 635 is capable of, configured to, or operable to support a means for transmitting an uplink control information message including an indication that a retransmission of the at least one retransmission is a last retransmission for the uplink message.

In some examples, the predictive model input component 645 is capable of, configured to, or operable to support a means for inputting, to the predictive model, one or more parameters including HARQ retransmission information, ARQ retransmission information, a discard rate, an RLC block error rate, a loss rate, latency information, or throughput information to obtain the output of the predictive model.

In some examples, the predictive model configuration component 625 is capable of, configured to, or operable to support a means for transmitting a control message indicating one or more key performance indicators associated with the predictive model, where the one or more key performance indicators includes an RLC PDU latency, an RLC PDU reliability, or an uplink packet discard rate.

In some examples, the RLC PDU latency and the RLC PDU reliability are determined per PDU set, per QoS flow, or per packet categorization.

In some examples, the capability information component 650 is capable of, configured to, or operable to support a means for transmitting a capability message indicating a capability of the UE to use the predictive model to determine whether to terminate uplink HARQ retransmission operation.

In some examples, the capability message indicates one or more key performance indicators associated with the predictive model and a model score associated with the predictive model based on the one or more key performance indicators.

In some examples, to support terminating the uplink HARQ operation for the uplink message, the uplink termination component 640 is capable of, configured to, or operable to support a means for discarding one or more uplink packets that are buffered for retransmission of the uplink message.

In some examples, the configuration information indicates a minimum quantity of retransmissions to attempt prior to terminating uplink HARQ retransmission operation, a minimum time before terminating the uplink HARQ retransmission operation, a maximum time before terminating the uplink HARQ operation, a parameter that configures the UE to use the predictive model, and identifiers for QoS flows, radio bearers, logical channels, or traffic types for which the UE is to use the predictive model to determine whether to terminate uplink HARQ retransmission operation, or any combination thereof.

In some examples, the configuration information indicates one or more key performance indicators associated with the predictive model, the one or more key performance indicators including a threshold RLC block error rate, a threshold HARQ block error rate, a threshold discard rate, a threshold quantity of wasted grants, a threshold latency, a threshold quantity of traffic that meets a latency target, a throughput target, or any combination thereof.

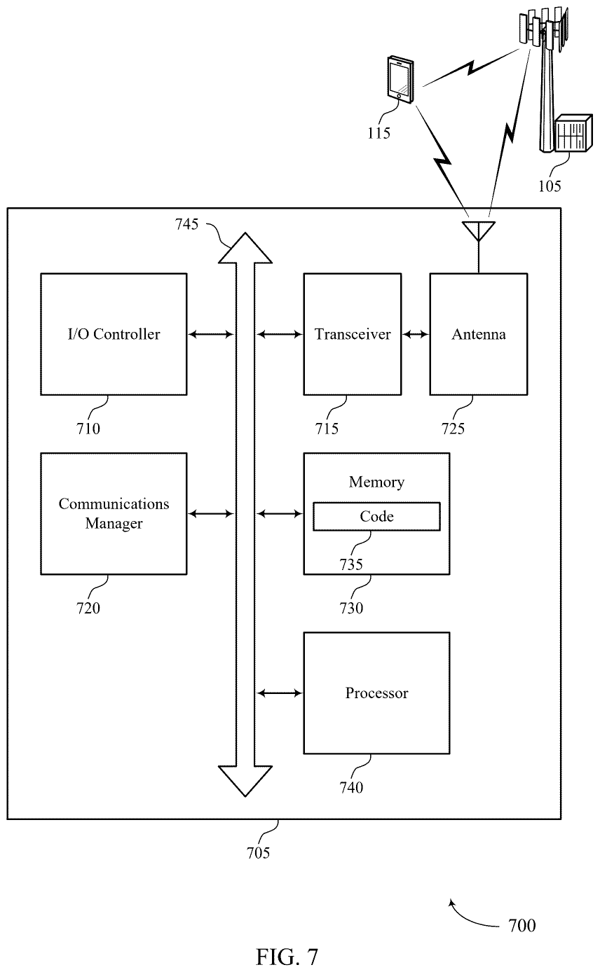

FIG. 7 shows a diagram of a system 700 including a device 705 that supports using a predictive model for uplink hybrid automatic repeat request retransmission in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting using a predictive model for uplink hybrid automatic repeat request retransmission). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving configuration information that configures the UE to use a predictive model to determine whether to terminate uplink HARQ retransmission operation. The communications manager 720 is capable of, configured to, or operable to support a means for transmitting an uplink message to a network entity. The communications manager 720 is capable of, configured to, or operable to support a means for receiving, from the network entity, an indication that the UE is to perform uplink HARQ retransmission for the uplink message. The communications manager 720 is capable of, configured to, or operable to support a means for terminating the uplink HARQ retransmission operation for the uplink message based on an output of the predictive model.

By including or configuring the communications manager 720 in accordance with examples as described herein, the device 705 may support techniques for reduced latency, improved user experience related to reduced processing, and more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of using a predictive model for uplink hybrid automatic repeat request retransmission as described herein, or the at least one processor 740 and the at least one memory 730 may be otherwise configured to, individually or collectively, perform or support such operations.

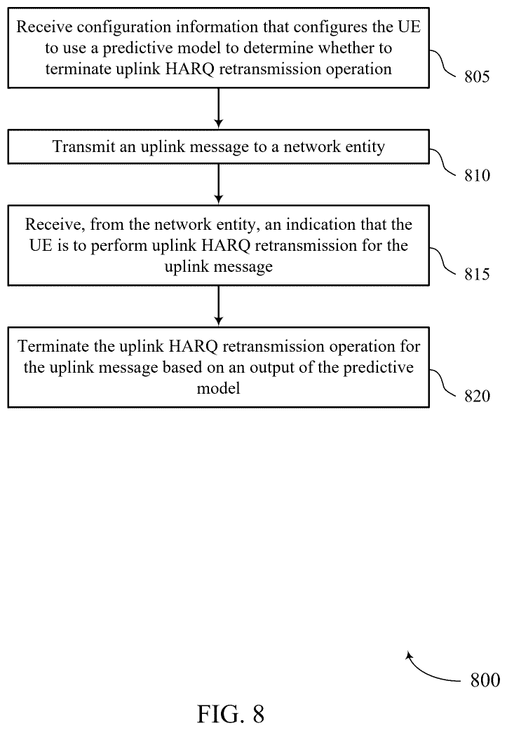

FIG. 8 shows a flowchart illustrating a method 800 that supports using a predictive model for uplink hybrid automatic repeat request retransmission in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving configuration information that configures the UE to use a predictive model to determine whether to terminate uplink HARQ retransmission operation. The operations of 805 may be performed in accordance with examples as disclosed herein. In some examples, aspects of the operations of 805 may be performed by a predictive model configuration component 625 as described with reference to FIG. 6.

At 810, the method may include transmitting an uplink message to a network entity. The operations of 810 may be performed in accordance with examples as disclosed herein. In some examples, aspects of the operations of 810 may be performed by an uplink transmission component 630 as described with reference to FIG. 6.

At 815, the method may include receiving, from the network entity, an indication that the UE is to perform uplink HARQ retransmission for the uplink message. The operations of 815 may be performed in accordance with examples as disclosed herein. In some examples, aspects of the operations of 815 may be performed by an HARQ feedback component 635 as described with reference to FIG. 6.

At 820, the method may include terminating the uplink HARQ retransmission operation for the uplink message based on an output of the predictive model. The operations of 820 may be performed in accordance with examples as disclosed herein. In some examples, aspects of the operations of 820 may be performed by an uplink termination component 640 as described with reference to FIG. 6.

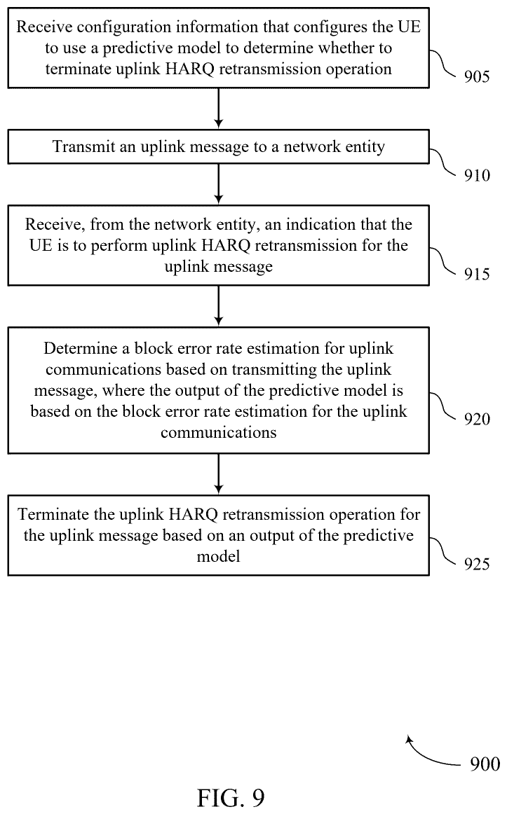

FIG. 9 shows a flowchart illustrating a method 900 that supports using a predictive model for uplink hybrid automatic repeat request retransmission in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving configuration information that configures the UE to use a predictive model to determine whether to terminate uplink HARQ retransmission operation. The operations of 905 may be performed in accordance with examples as disclosed herein. In some examples, aspects of the operations of 905 may be performed by a predictive model configuration component 625 as described with reference to FIG. 6.

At 910, the method may include transmitting an uplink message to a network entity. The operations of 910 may be performed in accordance with examples as disclosed herein. In some examples, aspects of the operations of 910 may be performed by an uplink transmission component 630 as described with reference to FIG. 6.

At 915, the method may include receiving, from the network entity, an indication that the UE is to perform uplink HARQ retransmission for the uplink message. The operations of 915 may be performed in accordance with examples as disclosed herein. In some examples, aspects of the operations of 915 may be performed by an HARQ feedback component 635 as described with reference to FIG. 6.

At 920, the method may include determining a block error rate estimation for uplink communications based on transmitting the uplink message, where the output of the predictive model is based on the block error rate estimation for the uplink communications. The operations of 920 may be performed in accordance with examples as disclosed herein. In some examples, aspects of the operations of 920 may be performed by a predictive model input component 645 as described with reference to FIG. 6.

At 925, the method may include terminating the uplink HARQ retransmission operation for the uplink message based on an output of the predictive model. The operations of 925 may be performed in accordance with examples as disclosed herein. In some examples, aspects of the operations of 925 may be performed by an uplink termination component 640 as described with reference to FIG. 6.

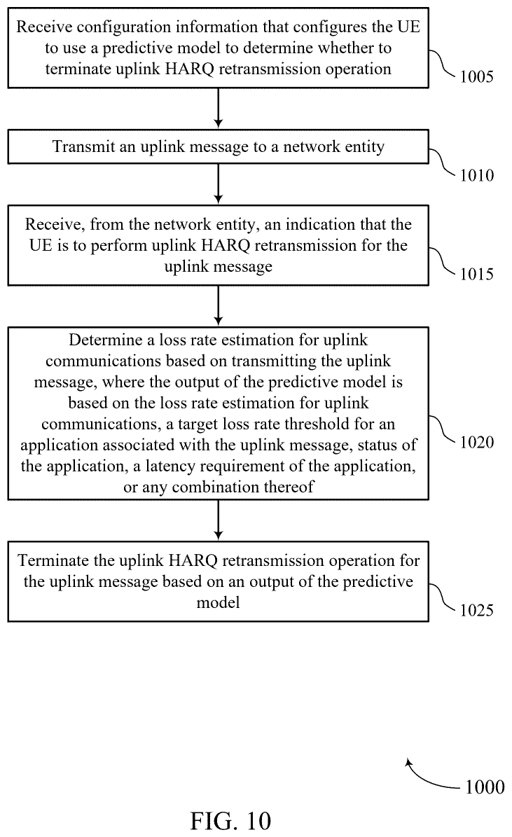

FIG. 10 shows a flowchart illustrating a method 1000 that supports using a predictive model for uplink hybrid automatic repeat request retransmission in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving configuration information that configures the UE to use a predictive model to determine whether to terminate uplink HARQ retransmission operation. The operations of 1005 may be performed in accordance with examples as disclosed herein. In some examples, aspects of the operations of 1005 may be performed by a predictive model configuration component 625 as described with reference to FIG. 6.

At 1010, the method may include transmitting an uplink message to a network entity. The operations of 1010 may be performed in accordance with examples as disclosed herein. In some examples, aspects of the operations of 1010 may be performed by an uplink transmission component 630 as described with reference to FIG. 6.

At 1015, the method may include receiving, from the network entity, an indication that the UE is to perform uplink HARQ retransmission for the uplink message. The operations of 1015 may be performed in accordance with examples as disclosed herein. In some examples, aspects of the operations of 1015 may be performed by an HARQ feedback component 635 as described with reference to FIG. 6.

At 1020, the method may include determining a loss rate estimation for uplink communications based on transmitting the uplink message, where the output of the predictive model is based on the loss rate estimation for uplink communications, a target loss rate threshold for an application associated with the uplink message, status of the application, a latency requirement of the application, or any combination thereof. The operations of 1020 may be performed in accordance with examples as disclosed herein. In some examples, aspects of the operations of 1020 may be performed by a predictive model input component 645 as described with reference to FIG. 6.

At 1025, the method may include terminating the uplink HARQ retransmission operation for the uplink message based on an output of the predictive model. The operations of 1025 may be performed in accordance with examples as disclosed herein. In some examples, aspects of the operations of 1025 may be performed by an uplink termination component 640 as described with reference to FIG. 6.

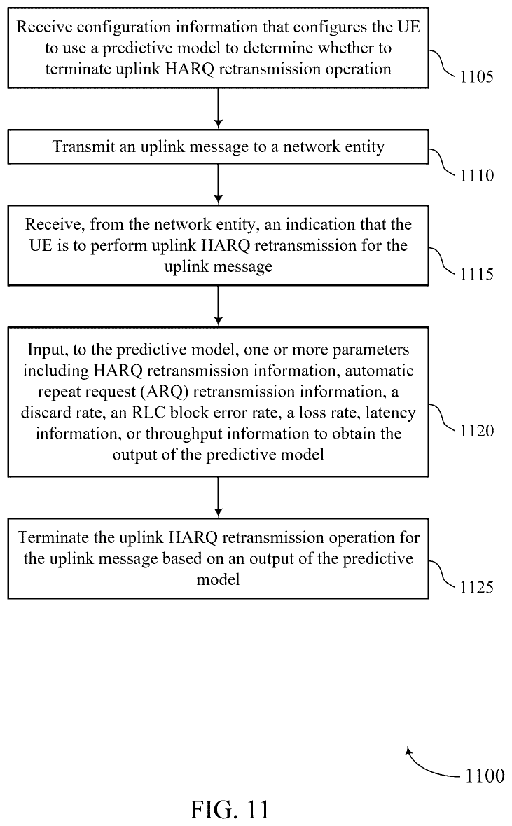

FIG. 11 shows a flowchart illustrating a method 1100 that supports using a predictive model for uplink hybrid automatic repeat request retransmission in accordance with one or more aspects of the present disclosure. The operations of the method 1100 may be implemented by a UE or its components as described herein. For example, the operations of the method 1100 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1105, the method may include receiving configuration information that configures the UE to use a predictive model to determine whether to terminate uplink HARQ retransmission operation. The operations of 1105 may be performed in accordance with examples as disclosed herein. In some examples, aspects of the operations of 1105 may be performed by a predictive model configuration component 625 as described with reference to FIG. 6.

At 1110, the method may include transmitting an uplink message to a network entity. The operations of 1110 may be performed in accordance with examples as disclosed herein. In some examples, aspects of the operations of 1110 may be performed by an uplink transmission component 630 as described with reference to FIG. 6.

At 1115, the method may include receiving, from the network entity, an indication that the UE is to perform uplink HARQ retransmission for the uplink message. The operations of 1115 may be performed in accordance with examples as disclosed herein. In some examples, aspects of the operations of 1115 may be performed by an HARQ feedback component 635 as described with reference to FIG. 6.

At 1120, the method may include inputting, to the predictive model, one or more parameters including HARQ retransmission information, ARQ retransmission information, a discard rate, an RLC block error rate, a loss rate, latency information, or throughput information to obtain the output of the predictive model. The operations of 1120 may be performed in accordance with examples as disclosed herein. In some examples, aspects of the operations of 1120 may be performed by a predictive model input component 645 as described with reference to FIG. 6.

At 1125, the method may include terminating the uplink HARQ retransmission operation for the uplink message based on an output of the predictive model. The operations of 1125 may be performed in accordance with examples as disclosed herein. In some examples, aspects of the operations of 1125 may be performed by an uplink termination component 640 as described with reference to FIG. 6.

The following provides an overview of aspects of the present disclosure:
Aspect 1: A method for wireless communications at a UE, comprising: receiving configuration information that configures the UE to use a predictive model to determine whether to terminate uplink HARQ retransmission operation; transmitting an uplink message to a network entity; receiving, from the network entity, an indication that the UE is to perform uplink HARQ retransmission for the uplink message; and terminating the uplink HARQ retransmission operation for the uplink message based at least in part on an output of the predictive model.
Aspect 2: The method of aspect 1, further comprising: determining a block error rate estimation for uplink communications based at least in part on transmitting the uplink message, wherein the output of the predictive model is based at least in part on the block error rate estimation for the uplink communications.
Aspect 3: The method of any of aspects 1 through 2, further comprising: determining a loss rate estimation for uplink communications based at least in part on transmitting the uplink message, wherein the output of the predictive model is based at least in part on the loss rate estimation for uplink communications, a target loss rate threshold for an application associated with the uplink message, status of the application, a latency requirement of the application, or any combination thereof.
Aspect 4: The method of any of aspects 1 through 3, wherein the output of the predictive model is based at least in part on a buffer status of a buffer at the UE, a power status of the UE, a resource availability status of the UE, a memory status of the UE, an application status, or any combination thereof.
Aspect 5: The method of any of aspects 1 through 4, wherein the output of the predictive model is based at least in part on a first quantity of HARQ retransmissions for the uplink message or a second quantity of automatic repeat request (ARQ) retransmissions for the uplink message, or both.
Aspect 6: The method of any of aspects 1 through 5, wherein the output of the predictive model is a terminating output, the method further comprising: transmitting at least one retransmission of the uplink message based at least in part on an early output of the predictive model, wherein the early output is determined prior to determination of the terminating output.
Aspect 7: The method of aspect 6, further comprising: multiplexing uplink control information with a transmission of the uplink message or a retransmission of the at least one retransmission, wherein the uplink control information comprises an indication that the retransmission is a last retransmission of the uplink message.
Aspect 8: The method of any of aspects 6 through 7, further comprising: transmitting an uplink control information message comprising an indication that a retransmission of the at least one retransmission is a last retransmission for the uplink message.
Aspect 9: The method of any of aspects 1 through 8, further comprising: inputting, to the predictive model, one or more parameters comprising HARQ retransmission information, automatic repeat request (ARQ) retransmission information, a discard rate, an RLC block error rate, a loss rate, latency information, or throughput information to obtain the output of the predictive model.
Aspect 10: The method of any of aspects 1 through 9, further comprising: transmitting a control message indicating one or more key performance indicators associated with the predictive model, wherein the one or more key performance indicators comprises an RLC protocol data unit (PDU) latency, an RLC PDU reliability, or an uplink packet discard rate.
Aspect 11: The method of aspect 10, wherein the RLC PDU latency and the RLC PDU reliability are determined per PDU set, per quality of service (QoS) flow, or per packet categorization.
Aspect 12: The method of any of aspects 1 through 11, further comprising: transmitting a capability message indicating a capability of the UE to use the predictive model to determine whether to terminate uplink HARQ retransmission operation.
Aspect 13: The method of aspect 12, wherein the capability message indicates one or more key performance indicators associated with the predictive model and a model score associated with the predictive model based at least in part on the one or more key performance indicators.
Aspect 14: The method of any of aspects 1 through 13, wherein terminating the uplink HARQ operation for the uplink message comprises: discarding one or more uplink packets that are buffered for retransmission of the uplink message.
Aspect 15: The method of any of aspects 1 through 14, wherein the configuration information indicates a minimum quantity of retransmissions to attempt prior to terminating uplink HARQ retransmission operation, a minimum time before terminating uplink HARQ transmission operation, as maximum time before terminating uplink HARQ transmission protocol data unit (PDU), a parameter that configures the UE to use the predictive model, and identifiers for quality of service (QoS) flows, radio bearers, logical channels, or traffic types for which the UE is to use the predictive model to determine whether to terminate uplink HARQ retransmission operation, or any combination thereof.
Aspect 16: The method of any of aspects 1 through 15, wherein the configuration information indicates one or more key performance indicators associated with the predictive model, the one or more key performance indicators comprising a threshold RLC block error rate, a threshold HARQ block error rate, a threshold discard rate, a threshold quantity of wasted grants, a threshold latency, a threshold quantity of traffic that meets a latency target, a throughput target, or any combination thereof.
Aspect 17: A UE for wireless communications, comprising one or more memories storing processor-executable code, and one or more processors coupled with the one or more memories and individually or collectively operable to execute the code to cause the UE to perform a method of any of aspects 1 through 16.
Aspect 18: A UE for wireless communications, comprising at least one means for performing a method of any of aspects 1 through 16.
Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information that configures the UE to use a predictive model to determine whether to terminate uplink hybrid automatic repeat request (HARQ) retransmission operation;
transmit an uplink message to a network entity;
receive, from the network entity, an indication that the UE is to perform uplink HARQ retransmission for the uplink message; and
terminate the uplink HARQ retransmission operation for the uplink message based at least in part on an output of the predictive model.

2. The UE of claim 1, wherein the one or more processors are individually or collectively further operable to execute the code to cause the UE to:
determine a block error rate estimation for uplink communications based at least in part on transmitting the uplink message, wherein the output of the predictive model is based at least in part on the block error rate estimation for the uplink communications.

3. The UE of claim 1, wherein the one or more processors are individually or collectively further operable to execute the code to cause the UE to:
determine a loss rate estimation for uplink communications based at least in part on transmitting the uplink message, wherein the output of the predictive model is based at least in part on the loss rate estimation for uplink communications, a target loss rate threshold for an application associated with the uplink message, status of the application, a latency requirement of the application, or any combination thereof.

4. The UE of claim 1, wherein the output of the predictive model is based at least in part on a buffer status of a buffer at the UE, a power status of the UE, a resource availability status of the UE, a memory status of the UE, an application status, or any combination thereof.

5. The UE of claim 1, wherein the output of the predictive model is based at least in part on a first quantity of HARQ retransmissions for the uplink message or a second quantity of automatic repeat request (ARQ) retransmissions for the uplink message, or both.

6. The UE of claim 1, wherein the output of the predictive model is a terminating output, and the one or more processors are individually or collectively further operable to execute the code to cause the UE to:
transmit at least one retransmission of the uplink message based at least in part on an early output of the predictive model, wherein the early output is determined prior to determination of the terminating output.

7. The UE of claim 6, wherein the one or more processors are individually or collectively further operable to execute the code to cause the UE to:
multiplex uplink control information with a transmission of the uplink message or a retransmission of the at least one retransmission, wherein the uplink control information comprises an indication that the retransmission is a last retransmission of the uplink message.

8. The UE of claim 6, wherein the one or more processors are individually or collectively further operable to execute the code to cause the UE to:
transmit an uplink control information message comprising an indication that a retransmission of the at least one retransmission is a last retransmission for the uplink message.

9. The UE of claim 1, wherein the one or more processors are individually or collectively further operable to execute the code to cause the UE to:
input, to the predictive model, one or more parameters comprising HARQ retransmission information, automatic repeat request (ARQ) retransmission information, a discard rate, a radio link control (RLC) block error rate, a loss rate, latency information, or throughput information to obtain the output of the predictive model.

10. The UE of claim 1, wherein the one or more processors are individually or collectively further operable to execute the code to cause the UE to:
transmit a control message indicating one or more key performance indicators associated with the predictive model, wherein the one or more key performance indicators comprises a radio link control (RLC) protocol data unit (PDU) latency, an RLC PDU reliability, or an uplink packet discard rate.

11. The UE of claim 10, wherein:
the RLC PDU latency and the RLC PDU reliability are determined per PDU set, per quality of service (QoS) flow, or per packet categorization.

12. The UE of claim 1, wherein the one or more processors are individually or collectively further operable to execute the code to cause the UE to:
transmit a capability message indicating a capability of the UE to use the predictive model to determine whether to terminate uplink HARQ retransmission operation.

13. The UE of claim 12, wherein the capability message indicates one or more key performance indicators associated with the predictive model and a model score associated with the predictive model based at least in part on the one or more key performance indicators.

14. The UE of claim 1, wherein, to terminate the uplink HARQ operation for the uplink message, the one or more processors are individually or collectively operable to execute the code to cause the UE to:
discard one or more uplink packets that are buffered for retransmission of the uplink message.

15. The UE of claim 1, wherein the configuration information indicates a minimum quantity of retransmissions to attempt prior to terminating uplink HARQ retransmission operation, a minimum time before terminating the uplink HARQ retransmission operation, a maximum time before terminating the uplink HARQ retransmission operation, a parameter that configures the UE to use the predictive model, and identifiers for quality of service (QoS) flows, radio bearers, logical channels, or traffic types for which the UE is to use the predictive model to determine whether to terminate uplink HARQ retransmission operation, or any combination thereof.

16. The UE of claim 1, wherein the configuration information indicates one or more key performance indicators associated with the predictive model, the one or more key performance indicators comprising a threshold radio link control (RLC) block error rate, a threshold HARQ block error rate, a threshold discard rate, a threshold quantity of wasted grants, a threshold latency, a threshold quantity of traffic that meets a latency target, a throughput target, or any combination thereof.

17. A method for wireless communications at a user equipment (UE), comprising:
receiving configuration information that configures the UE to use a predictive model to determine whether to terminate uplink hybrid automatic repeat request (HARQ) retransmission operation;
transmitting an uplink message to a network entity;
receiving, from the network entity, an indication that the UE is to perform uplink HARQ retransmission for the uplink message; and
terminating the uplink HARQ retransmission operation for the uplink message based at least in part on an output of the predictive model.

18. The method of claim 17, further comprising:
determining a block error rate estimation for uplink communications based at least in part on transmitting the uplink message, wherein the output of the predictive model is based at least in part on the block error rate estimation for the uplink communications.

19. The method of claim 17, further comprising:
determining a loss rate estimation for uplink communications based at least in part on transmitting the uplink message, wherein the output of the predictive model is based at least in part on the loss rate estimation for uplink communications, a target loss rate threshold for an application associated with the uplink message, status of the application, a latency requirement of the application, or any combination thereof.

20. A non-transitory computer-readable medium storing code for wireless communications, the code comprising instructions executable by one or more processors to:
receive configuration information that configures a user equipment (UE) to use a predictive model to determine whether to terminate uplink hybrid automatic repeat request (HARQ) retransmission operation;
transmit an uplink message to a network entity;
receive, from the network entity, an indication that the UE is to perform uplink HARQ retransmission for the uplink message; and
terminate the uplink HARQ retransmission operation for the uplink message based at least in part on an output of the predictive model.
